(19) United States
(12) Patent Application Publication
(10) Pub. No.: US 2006/0182237 A1
(43) Pub. Date: Aug. 17, 2006

(54) System and method for healthcare personnel notification and tracking

(76) Inventors: Brian DelMonego, Chester Springs, PA (US); Betty Fink, Bear, DE (US); Gary Grzywacz, Harleysville, PA (US); James Pressler, West Chester, PA (US); Donald Taylor, Downingtown, PA (US); Arnold Teres, Broomall, PA (US)

Correspondence Address: Siemens Corporation;Intellectual Property Department, 170 Wood Avenue South, Iselin, NJ, 08830, US

(21) Appl. No.: 11/274,675

(22) Filed: Nov. 15, 2005

Related U.S. Application Data
(60) Provisional application No. 60/628,499, filed on Nov. 16, 2004.

(51) Int. Cl. H04M 1/64

(52) U.S. Cl. 379/88.17

(57) ABSTRACT

The embodiments of the present invention relate to a system and method for notifying healthcare personnel including identifying a particular notification recipient, identifying at least one predetermined notification rule for the particular recipient, selecting a device of the recipient to receive a notification message, the device being selected according to the at least one predetermined notification rule, notifying the particular recipient by dispatching the notification message, and optionally tracking the notification message, wherein user determines whether the recipient has received and read the notification message.

This is a non-provisional application of Provisional Application Ser. No. 60/628,499 to DelMonego et al., filed Nov. 16, 2004.

### FIELD OF THE INVENTION

The embodiments of the present invention relate to a computer implemented resource management system and method, and in particular, to a system and method for managing and allocating the resources of a hospital or healthcare facility department in real time.

### BACKGROUND OF THE INVENTION

In delivering healthcare to a patient, it frequently occurs that in order for a clinician to make a decision, help from another healthcare worker (e.g., a physician or nurse) is needed. Often times, it is difficult and tedious to obtain correct contact information for the person sought (e.g., correct phone number, mobile number, address, or e-mail address). For example, where a particular physician may be needed to review a case history and render an opinion, a secretary may attempt to locate the physician by telephone, electronic mail or any other available method. However, there are often difficulties involved with locating the physician, which delays the process of rendering the opinion. Further, in emergency situations for example, there may be little time in which to contact a physician for an opinion. It is also difficult to identify a best way to contact someone with regard to an alert or notification.

Thus, there is a need within the industry for a system and method that quickly provides notification, either manually or automatically, to a particular recipient that their input is desired in a particular matter.

### SUMMARY OF THE INVENTION

An exemplary embodiment of the present invention comprises a system and method for notifying personnel including receiving information to initiating sending at least one notification message in real time, identifying a particular notification recipient, identifying at least one predetermined notification rule for the particular recipient, selecting a device of the recipient to receive a notification message, the device being selected according to the at least one predetermined notification rule, notifying the particular recipient by dispatching the notification message, and optionally tracking the notification message and generating a report, wherein user determines whether the recipient has received and read the notification message.

### BRIEF DESCRIPTION OF THE DRAWINGS

FIG. 1 is a block diagram showing a computer system according to an exemplary embodiment of the present invention

FIG. 2 is a block diagram showing a computer system according to an exemplary embodiment of the present invention.

FIG. 3 is a block diagram showing a method according to an exemplary embodiment of the present invention.

### DETAILED DESCRIPTION

Although the embodiments of the present invention are described in the context of medical systems and facilities, this is exemplary only. The embodiments of the present invention are also applicable in other medical systems, disciplines (e.g., veterinary medicine, dentistry) and industries.

An exemplary embodiment of the present invention comprises a computer-implemented system and method for resource management, where the resources of a hospital or health care facility department are managed and allocated in real time. The system employs a passive, non-intrusive notification function within the radiology information system. The system runs on a desktop, where the notification system runs in (or in conjunction with) a radiology information system or within another application available on different devices.

Typically, the system provides for the real time notification of personnel (e.g., a physician, nurse or other clinician) in those instances where communication between or among personnel is necessary. The system utilizes at least one predetermined rule, preferably more than one rule, to determine the most effective and efficient notification pathway(s) for a particular potential recipient. The predetermined rules are an inquiry or series of inquiries, such that addressing each inquiry assists in further defining the final notification pathway(s). Moreover, the at least one predetermined rules can be manipulated to where further rules may be added or deleted. For example, the at least one predetermined rule includes, but is not limited to:

1. Time of day;

2. Day of the week;

3. Who to contact (the recipient);

4. When to contact the particular recipient;

5. Where to contact the particular recipient; and

6. How to contact to particular recipient.

Thus, based on the at least one predetermined rule, the system determines and selects the most efficient and effective appropriate notification pathway to contact the appropriate recipient for their input (e.g., a second opinion) in real time. Thus, any delay in notifying personnel is greatly reduced or eliminated.

The notification message is sent by a radiology information system user or automatically by the radiology information system where contact with another party is necessary. The at least one predetermined rule is also configured to send notification messages to more than one recipient. The notification method initiates either manually by a user or automatically by the system itself based upon a particular notification event such as, for example, the indication in a report or database that a second medical opinion or medical follow-up is needed. The notification event is configured and defined by the Information-System-Administrator.

The notification recipient receives the notification message on his RIS-Interface, but it could be any other user interface (e.g., a mobile phone, telephone mail box, sms (short message system), and/or Blackberry® or other PDA). The system checks the notification possibilities and devices based upon addressing the at least one predetermined rule in order to connect with the recipient and how to most efficiently send the notification message. For example in using a PDA, upon receiving the notification message by a recipient, a displayed user interface image of the notification is displayed in real time such as a Message box that fades to the forefront to obtain attention of a notified person. The display user interface image present options and actions available. The notification message is sent from the system automatically or by manual selection and is usable for: (1) high priority procedures, (2) instant messages, and (3) a party simply trying to notify a particular recipient that their assistance is needed.

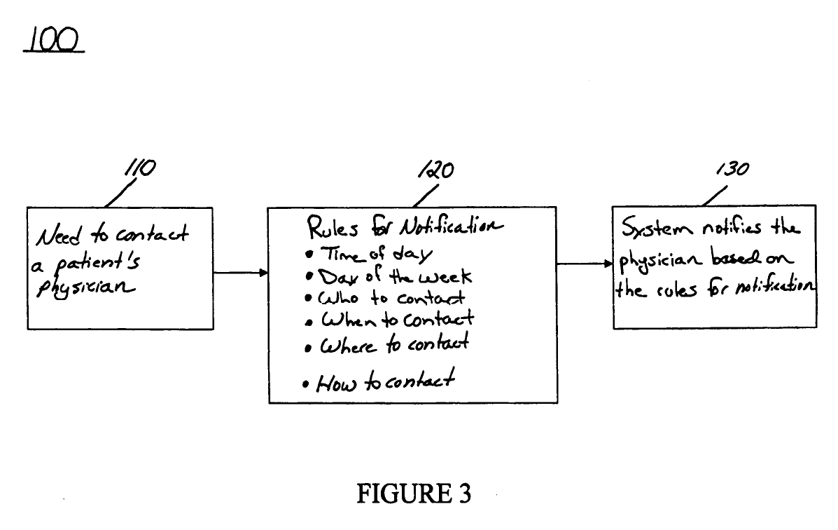

The system is usable as part of a radiology information system or as a stand alone application. An exemplary embodiment of the system employs 3 modules (discussed later in connection with FIG. 3). The modules support: (1) contact of a patient's physician where the contact (notification recipient) may be selected manually in the case when the radiology information system user decides to contact another party. Alternatively, the notification recipient may be recognized automatically by the software based on the at least one predetermined rule, for example in a situation where a decision process needs a second opinion; (2) at least one predetermined rule for determining the appropriate notification pathway; and (3) notifying the physician.

The notification message may have different forms and may include attachments including, but not limited to, images, reports, abstracts from reports and further comprises a short notification message to another person making sure that the recipient receives and reads the notification.

The appearance of the notification message and the receiving device are not restricted. The system selects the device of the receiver and sends a massage that may be displayed on the device.

Tracking of the notification is an option that may be adapted by the Information Systems Administrator. This allows a user to see if the addressed person received and read the notification. Thus the notification message also includes a receipt and/or read message that is automatically generated and returned to the user upon the recipient acknowledging or opening the notification message. However, if the receipt or read message is not returned, the system generates at least a second notification message in an attempt to confirm that the notification message has been received. This is all performed in real time such that the user effectively and quickly determines whether a recipient has been alerted to the fact that their input or assistance is required.

In addition, a report may be generated that shows the tracking of the notification message, such that a hospital administrator is able to view the number of notification attempts, devices notified and whether the notification was properly responded to or a subsequent notification had to be sent.

In an exemplary system according to the embodiments of the present invention, a patient has a “STAT” (emergency) procedure performed in the radiology department. The radiologist desires to discuss the findings with the patient's physician. The radiologist requests the radiology information system to track down the patient's physician. Based on the predetermined rules for notification, the radiology information system tracks down the physician. The predetermined rules for notification include:

1. To send a message to the selected recipient's cell phone;

2. Contact the recipient's office;

3. Page the recipient; and

4. Send an e-mail or Instant Message to the recipient.

In an another exemplary system according to the present invention, a multi-entity hospital that has site A campus and site B campus that are at least 50 miles apart. A radiologist at site A has a difficult case that he/she would like to review with a colleague at site B. The radiologist at site A has the radiology information system track down the colleague at site B. Once the colleague has been notified they discuss the case. As a result of the automated system where the radiology information system notifies and tracks down the colleague, the radiologist at site A is still being productive as he/she has been freed from the burden of having to attempt to contact the colleague at site B.

The embodiments of the present invention are preferably implemented on a computer, or network of computers as an executable application. The executable application displays on a computer screen, a display image representing the notification message as well as other options and actions available to the recipient.

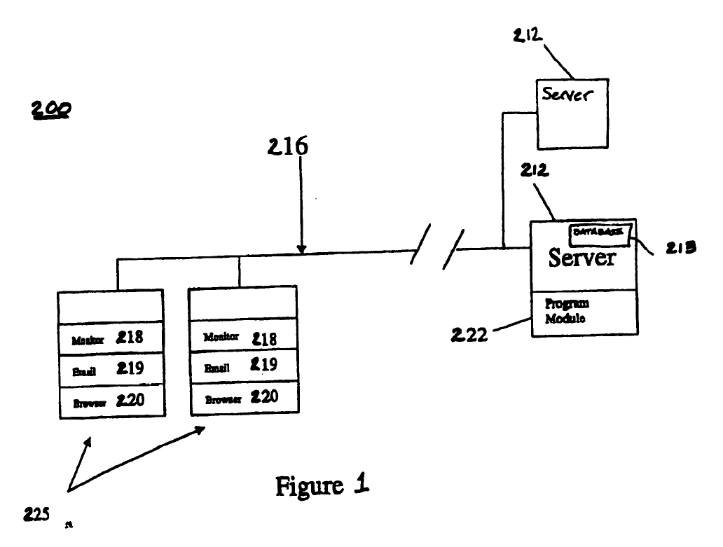

The embodiments of the present invention preferably also include a client-server computer system 200 (FIG. 1), which may be utilized to carry out a method according to an exemplary embodiment of the present invention. The computer system 200 includes a plurality of server computers 212 and a plurality of user computers 225. The server computers 212 and the user computers 225 may be connected by a network 216, such as for example, an Intranet or the Internet. The user computers 225 may be connected to the network 216 by a dial-up modem connection, a Local Area Network (LAN), a Wide Area Network (WAN), cable modem, digital subscriber line (DSL), or other equivalent connection means (whether wired or wireless).

Each user computer 225 preferably includes a video monitor 218 for displaying information. Additionally, each user computer 225 preferably includes an electronic mail (e-mail) program 219 (e.g., Microsoft Outlook®) and a browser program 220 (e.g. Microsoft Internet Explorer®, Netscape Navigator®, etc.), as is well known in the art. Each user computer 225 may also include various other programs to facilitate communications (e.g., Instant Messenger™, NetMeeting™, etc.), as is well known in the art.

One or more of the server computers 212 preferably include a program module 222 (i.e., the executable application described above) which allows the user computers 225 to communicate with the server computers 212 and each other over the network 216. The program module may include program code, preferably written in Hypertext Mark-up Language (HTML), JAVA™ (Sun Microsystems, Inc.), Active Server Pages (ASP) and/or Extensible Markup Language (XML), which allows the user computers 225 to access the program module through browsers 220 (i.e., by entering a proper Uniform Resource Locator (URL) address). The exemplary program module also preferably includes program code for facilitating a method of simulating leadership activity among the user computers 225, as explained in detail below.

At least one of the server computers 212 also includes a database 213 for storing information utilized by the program module 222 in order to carry out the embodiments of the system and method for notifying and optionally tracking healthcare personnel. The data representing the potential recipients, the at least one predetermined rule, and the contact information for each recipient is stored in the database 213. Although the database 213 is preferably internal to the server, those of ordinary skill in the art will realize that the database may alternatively comprise an external database. Additionally, although the database is preferably a single database, those of ordinary skill in the art will realize that the present computer system may include one or more databases coupled to the network.

The embodiment of the present invention also includes a computer-readable medium having embodied thereon a computer program for processing by a machine, the computer program comprising a segment of code for each of the method steps. The embodiments of the present invention also include a computer data signal embodied in a carrier wave comprising each of the aforementioned code segments.

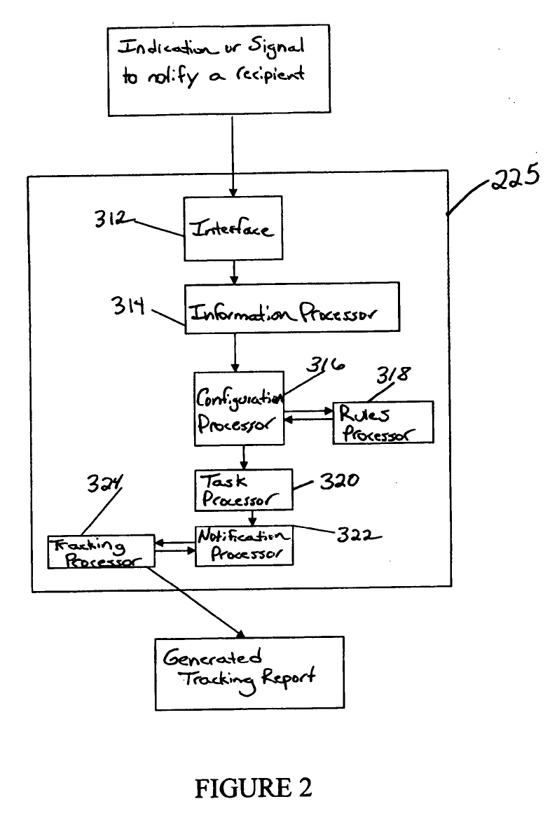

In order to perform some of the functions of the method for at least one of the user computers 225 or server computers 212 may include an interface 312 (FIG. 2) for receiving an indication (e.g., a keystroke or mouse click or signal when done automatically) that a user desires to send a notification message, an information processor 314 for identifying a particular notification recipient, a configuration processor 316 for identifying at least one predetermined notification rule for the particular recipient, a task processor 320 for selecting a device(s) of the recipient to receive a notification message, the device(s) being selected according to the at least one predetermined notification rule; and a notification processor 322 for notifying the particular recipient by dispatching the notification message. At least one of the user computers 225 or server computers 212 may also include a rules processor 318 whereby one or more of the at least one predetermined notification rule may be added or deleted. At least one of the user computers 225 (FIG. 1) or server computers 212 may also include a tracking processor 324 for tracking the notification message and generating of a report showing the notification pathway(s).

FIG. 3 is a block flow diagram showing an exemplary method 100 for notifying healthcare personnel that includes a first step 110 of a user indicating the need to contact another healthcare professional such as, for example, a patient's physician. At step 120, the at least one predetermined rule for the particular physician is addressed to determine the most efficient and effective notification pathway. At step 130, the physician is notified that his/her input is needed for a particular matter.

An executable application as used herein comprises code or machine-readable instruction for implementing pre-determined functions, including those of an operating system, healthcare information system or other information processing systems, for example, in response to a user command or input. An executable procedure is a segment of code (machine-readable instruction), subroutine, or other distinct section of code or portion of an executable application for performing one or more particular processes and may include performing operations on received input parameters (or in response to received input parameters) and provide resulting output parameters.

A processor as used herein is a device and/or set machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention.

What is claimed is:

1. A system for ordering medical procedures comprising:
an interface for receiving information to initiate sending at least one notification message in real time;
an information processor for identifying a particular notification recipient;
a configuration processor for identifying at least one predetermined notification rule for the particular recipient;
a task processor for selecting a device of the recipient to receive the at least one notification message, the device being selected according to the at least one predetermined notification rule; and
a notification processor for notifying the particular recipient by dispatching at least one notification message.

2. The system according to claim 1, further comprising:
a tracking processor for tracking the at least one notification message and generating a report.

3. The system according to claim 1, further comprising:
a rules processor for adding and deleting at least one predetermined notification rule.

4. A method for notifying healthcare personnel comprising:
an interface for receiving information to initiate sending at least one notification message in real time;
identifying a particular notification recipient;
identifying at least one predetermined notification rule for the particular recipient;
selecting a device of the recipient to receive the at least one notification message, the device being selected according to the at least one predetermined notification rule; and
notifying the particular recipient by dispatching the at least one notification message.

5. The method according to claim 3, further comprising:
tracking the at least one notification message and generating a report, wherein user determines whether the recipient has received and read the notification message.

6. The method according to claim 3, further comprising:
adding and deleting at least one predetermined notification rule.

7. A computer system comprising: at least one server computer; and at least one user computer coupled to at least one server through a network, wherein the at least one server computer includes at least one program stored therein, said program performing the steps of:
an interface for receiving information to initiate sending at least one notification message in real time;
identifying a particular notification recipient;
identifying at least one predetermined notification rule for the particular recipient;
selecting a device of the recipient to receive the at least one notification message, the device being selected according to the at least one predetermined notification rule; and
notifying the particular recipient by dispatching the at least one notification message.

8. The system according to claim 5, further comprising:
tracking the at least one notification message and generating a report, wherein user determines whether the recipient has received and read the notification message.

9. The system according to claim 5, further comprising:
adding and deleting at least one predetermined notification rule.

10. A computer readable medium having embodied thereon a computer program for processing by a machine, the computer program comprising:
a first code segment for an interface for receiving information to initiate sending at least one notification message in real time;
a second code segment identifying a particular notification recipient;
a third code segment for identifying at least one predetermined notification rule for the particular recipient;
a fourth code segment for selecting a device of the recipient to receive the at least one notification message, the device being selected according to the at least one predetermined notification rule; and
a fifth code segment for notifying the particular recipient by dispatching the at least one notification message.

11. The medium according to claim 10, further comprising:
a sixth code segment for tracking the at least one notification message and generating a report, wherein user determines whether the recipient has received and read the notification message.

12. A computer data signal embodied in a carrier wave comprising:
a first code segment for an interface for receiving information to initiate sending at least one notification message in real time;
a second code segment for identifying a particular notification recipient;
a third code segment for identifying at least one predetermined notification rule for the particular recipient;
a fourth code segment for selecting a device of the recipient to receive the at least one notification message, the device being selected according to the at least one predetermined notification rule; and
a fifth code segment for notifying the particular recipient by dispatching the at least one notification message.

13. The medium according to claim 9, further comprising:
a sixth code segment for tracking the at least one notification message and generating a report, wherein user determines whether the recipient has received and read the notification message.
